(19) United States
(12) Patent Application Publication
(10) Pub. No.: US 2015/0197618 A1
(43) Pub. Date: Jul. 16, 2015

(54) FILLER, GLASS COMPOSITION AND METHOD FOR PRODUCING HEXAGONAL PHOSPHATE

(71) Applicant: TOAGOSEI CO., LTD., Tokyo (JP)

(72) Inventors: Miki Tachibana, Nagoya-shi (JP); Yasuharu Ono, Nagoya-shi (JP)

(73) Assignee: TOAGOSEI CO., LTD., Tokyo (JP)

(21) Appl. No.: 14/419,849

(22) PCT Filed: Jul. 29, 2013
(86) PCT No.: PCT/JP2013/070424

§ 371 Date: Feb. 5, 2015

(30) Foreign Application Priority Data
Aug. 6, 2012 (JP) 2012-174192
Aug. 6, 2012 (JP) 2012-174193

(51) Int. Cl. C08K 3/32; C03C 8/24

(52) U.S. Cl. CPC C08K 3/32; C03C 8/24; C08K 2003/325; C08K 2003/328; C08K 2003/327

(57) ABSTRACT

The filler of the present invention is characterized by comprising hexagonal phosphate particles represented by formula (1) and having a median diameter of 0.05 μm or more and 10 μm or less based on the volume as measured by a laser diffraction particle size analyzer.

The method for producing a hexagonal phosphate of the present invention is characterized by comprising the steps of: mixing a tetravalent laminar metal phosphate, a compound of at least one divalent metal selected from the group consisting of alkaline earth metals, Zn, Cu, Ni and Mn, and an m-valent metal compound to obtain a mixture; and calcinating the mixture to obtain a hexagonal phosphate represented by formula (1).

AₓB_{y}C_{z}(PO₄)₃.nH₂O (1)

### TECHNICAL FIELD

The present invention relates to a filler comprising hexagonal phosphate particles and a glass composition including the filler. The composition including the filler of the present invention has a low coefficient of thermal expansion, and thus can be used for a sealing material for electronic components typically including cathode-ray tubes, plasma display panels (PDPs), a vacuum fluorescent display, an organic EL and the like.

The present invention also relates to a method for producing a hexagonal phosphate using a tetravalent laminar metal phosphate as a starting material. The hexagonal phosphate obtained by the present production method can be used as a filler of compositions including glass, resins and the like in order to reduce the coefficient of thermal expansion of cured articles, and thus can be applied for a sealing material for electronic components typically including cathode-ray tubes, plasma display panels (PDPs), a vacuum fluorescent display, an organic EL and the like.

### BACKGROUND ART

Phosphate salts include amorphous salts and crystalline salts having two-dimensional laminar structures and three-dimensional network structures. Among these, crystalline phosphates having three-dimensional network structures have excellent thermal stability, chemical resistance and resistance to radiation as well as excellent low thermal expansion. Thus, it has been considered to use the crystalline phosphates having three-dimensional network structures for solidification of radioactive wastes and as solid electrolytes, gas adsorption/separating agents, catalysts, starting materials for antibacterial agents and low thermal expansion fillers.

Low thermal expansion fillers including various phosphate salts have been known and used for sealing materials. For example, Patent Document 1 discloses a sealing material including a mixture of low melting point glass powder and powder of a low thermal expansion material such as NaZr₂(PO₄)₃, CaZr₂(PO₄)₃ or KZr₂(PO₄)₃. Patent Document 2 discloses NbZr₂(PO₄)₃ powder which is a powder filler for lead-free glass and Patent Document 3 discloses Zr₂(WO₄)(PO₄)₂ powder.

In addition, Patent Document 4 discloses a low thermal expansion filler represented by the formula: M1ₐ₁M2ₐ₂M3ₐ₃Zr_{b}Hf_{c}(PO₄)₃.nH₂O, addition of which in a small amount to a glass composition can significantly reduce the coefficient of thermal expansion of the glass composition and confer excellent flowability to the glass composition.

Patent Document 1: JP-A-H02-267137 (JP-A denotes a Japanese unexamined patent application publication)

Patent Document 2: JP-A-2000-290007

Patent Document 3: JP-A-2005-035840

Patent Document 4: JP-A-2007-302532

### DISCLOSURE OF THE PRESENT INVENTION

### Problems that the Present Invention is to Solve

Lead-free low melting point glasses which have recently been commonly used generally have higher coefficient of thermal expansion than conventional lead glasses. Therefore the conventional low thermal expansion fillers such as those disclosed in Patent Documents 1 to 3 may not be sufficient for providing the effects, and addition of the fillers in a large amount may not be able to sufficiently reduce the coefficient of thermal expansion of sealing materials or may impair flowability of sealing material compositions and melt-flowability of sealing materials.

In Patent Document 4, it is defined that M1 is an alkali metal; M2 is an alkaline earth metal; M3 is a hydrogen atom; a1 to a3 are respectively 0 or a positive number, provided that not all a1 to a3 are 0; b is a positive number; c is 0 or a positive number; and n is 0 or a positive number of no more than 2. In the Detailed Description of the Invention in Patent Literature 4, it is indicated that a1>a2>a3 is preferable because such a filler can sufficiently control low thermal expansion, and only an embodiment in which a1 is a positive number and a2 and a3 are 0 is described. Namely, it can be construed that, although a low thermal expansion filler represented by the formula: M1ₐ₁M2ₐ₂M3ₐ₃Zr_{b}Hf_{c}(PO₄)₃.nH₂O has been known, only a filler with an alkali metal salt is preferred, and a filler that does not contain an alkali metal has not been known with regard to the properties thereof. Further, a method for producing crystalline fine particles, which do not contain an alkali metal and are suitable for a low thermal expansion filler, has not been specifically known.

However, as electronic components are increasingly miniaturized and become accurate, sealing glasses and low thermal expansion fillers have been required to be devoid of an alkali metal because an alkali metal such as Na and K in substrates and sealing materials may adversely affect the reliability of electronic components. In this context, the production method of the low thermal expansion filler disclosed in Patent Document 4 may pose a problem. While Patent Document 4 indicates that hexagonal zirconium phosphate, which is obtained by a production method such as a hydrothermal method in which starting materials are mixed in water or in an atmosphere containing water followed by heating while applying pressure and a wet method in which starting materials are mixed in water followed by heating under normal pressure, has superior effects compared to conventional low thermal expansion fillers obtained by mixing starting materials and then calcinating the mixture at 1000° C. or higher in a calcination furnace, it has been difficult to obtain crystalline fine particles suitable for a filler from starting materials devoid of alkali metal because the water solubility of starting materials and intermediates significantly affects crystalline properties of the salt in the hydrothermal method or the wet method.

Thus, there is an increasing demand for a low thermal expansion filler that can significantly decrease the coefficient of thermal expansion of resins and glass compositions in a small amount and give excellent flowability to the glass compositions and that does not contain an alkali metal, because conventional low thermal expansion fillers do not provide such effects.

Therefore, an object of the present invention is to provide a filler which does not contain an alkali metal in the composition thereof and can significantly decrease the coefficient of thermal expansion when added to a glass composition in a small amount, and a glass composition containing the filler.

Another object of the present invention is to provide a method for producing a hexagonal phosphate that does not contain an alkali metal in the composition thereof and can be suitably used for the filler described above, in a simple and industrially advantageous manner.

The inventors of the present invention have made intensive studies to achieve the above objects and, as a result, found that a production method in which phosphate particles are used as a starting material and calcination is carried out to crystallize a hexagonal phosphate can provide hexagonal phosphate particles that do not contain an alkali metal in the composition thereof and are fine particles. The inventors have also found that by using the obtained hexagonal phosphate particles as a filler in a glass composition, the glass composition having excellent flowability and low thermal expansion can be obtained. The present invention pertains to the filler as well as the glass composition including the filler, as described above.

The inventors of the present invention have also made intensive studies to achieve the above objects and, as a result, found a novel method for producing a hexagonal phosphate in which starting materials including laminar phosphate particles are mixed and then calcination is carried out to crystallize the hexagonal phosphate. Thus, the inventors have completed the present invention.

### BRIEF DESCRIPTION OF DRAWINGS

FIG. 1 is an X-ray diffraction pattern of hexagonal phosphate A prepared in Example 1; and

FIG. 2 is an X-ray diffraction pattern of hexagonal phosphate g prepared in Comparative Example 1.

### EXPLANATION OF REFERENCE NUMERALS AND SYMBOLS

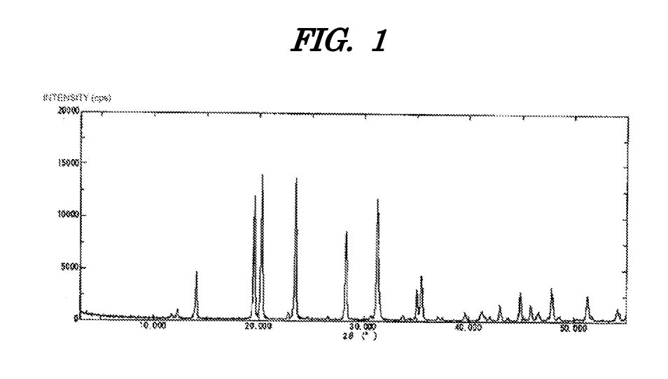

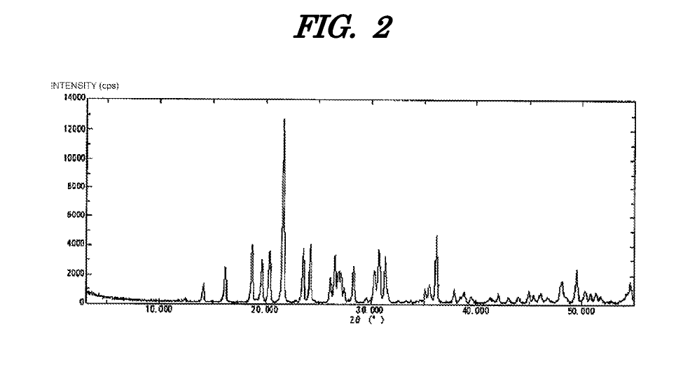

The vertical axis in FIGS. 1 and 2 indicates the X-ray diffraction intensity (unit: cps).

The horizontal axis in FIGS. 1 and 2 indicates the diffraction angle 2θ (unit: °).

### MODE FOR CARRYING OUT THE PRESENT INVENTION

The present invention is hereinafter described. Unless otherwise specified, “%” means “% by weight”, “part(s)” means “part(s) by weight” and “ppm” means “weight ppm”. As used herein, the expression “a lower limit to an upper limit” for presenting a numerical range denotes “a lower limit to an upper limit inclusive” and the expression “an upper limit to a lower limit” denotes “an upper limit to a lower limit inclusive”, namely, the numerical range including the upper limit and the lower limit is intended thereby. Moreover, combinations of two or more preferable embodiments described hereinbelow are also preferable embodiments of the present invention.

The filler of the present invention is most profoundly characterized in that it does not contain an alkali metal which may adversely affect electronic materials. There has been no low thermal expansion filler that has the composition represented by formula (1) and has a median diameter of 0.05 to 50 μm. The filler could be obtained for the first time by selecting a particle diameter of a starting material, a tetravalent laminar metal phosphate, and using a production method in which a three-component system of the tetravalent laminar metal phosphate, a particular divalent metal compound and a particular m-valent metal compound is prepared followed by heating and calcination. A glass composition containing the filler of the present invention can meet the requirements for providing fine shapes, and a cured article obtained therefrom exhibits excellent low thermal expansion. A filler of the present invention may also be hereinafter referred to as “low thermal expansion filler of the present invention”.

A filler of the present invention is a hexagonal phosphate represented by the following formula (1):

AₓB_{y}C_{z}(PO₄)₃.nH₂O (1)

In formula (1), A is at least one divalent metal selected from the group consisting of alkaline earth metals, Zn, Cu, Ni and Mn; B is at least one tetravalent metal selected from the group consisting of Zr, Ti, Hf, Ce and Sn; and C is a m-valent metal.

The indices x, y and z of A, B and C, respectively, are the numbers satisfying 1.75<y+z<2.25 and 2x+4y+mz=9 and x, y and z are positive numbers; n is 0 or a positive number of no more than 2; and m is an integer of 3 to 5. In the legend of formula (1) in the present invention, B does not mean an atomic symbol of boron and C does not mean an atomic symbol of carbon.

In formula (1), preferable A, B and C correspond to preferable compounds used as a starting material described hereinbelow.

A divalent metal of A is preferably at least one selected from the group consisting of Mg, Ca, Ba and Zn, more preferably at least one selected from the group consisting of Mg, Ca and Zn, and yet more preferably at least one selected from the group consisting of Ca and Mg. Two or more of these metals may be used in combination. A tetravalent metal of B is preferably at least one tetravalent metal selected from the group consisting of Ti, Zr, Sn and Hf, and more preferably at least one tetravalent metal selected from the group consisting of Ti, Zr and Hf. Two or more of these metals may be used in combination. An m-valent metal of C is preferably at least one selected from the group consisting of Zr, Ti, Hf, Ce, Sn, V, Nb, Al, Ga, Sc, Y and La, more preferably at least one selected from the group consisting of Zr, Ti, Hf, Nb, Al and Y, and yet more preferably at least one selected from the group consisting of Zr, Ti, Nb and Al. Two or more of these metals may be used in combination and in this case, two or more C metals may differ in m.

In formula (1), x is preferably a positive number of less than 1, more preferably 0.4 to 0.6, and yet more preferably 0.45 to 0.55. In formula (1), within the range satisfying 1.75<y+z<2.25, y is preferably above 1.0, more preferably not less than 1.25, and yet more preferably not less than 1.50, and y is preferably not more than 2.25, and z is preferably not more than 1.0, more preferably not more than 0.75, and yet more preferably in the range of 0.1 to 0.6.

In formula (1), n is preferably, in view of the stability of the hexagonal phosphate when it is included in a composition, not more than 1, more preferably 0≦n≦0.5, yet more preferably 0≦n≦0.3, and particularly preferably n=0.

Examples of the filler of the present invention include the followings:

Ca_{0.5}Zr₂(PO₄)₃

Mg_{0.5}Zr₂(PO₄)₃

Zn_{0.5}Zr₂(PO₄)₃

Ca_{0.45}Zr_{1.9}Nb_{0.1}(PO₄)₃

Ca_{0.4}Zr_{1.8}Nb_{0.2}(PO₄)₃

Ca_{0.35}Zr_{1.7}Nb_{0.3}(PO₄)₃

Ca_{0.25}Zr_{1.5}Nb_{0.5}(PO₄)₃

Ca_{0.5}Ti₂(PO₄)₃

Ca_{0.5}Zr_{1.5}Ti_{0.5}(PO₄)₃

Ca_{0.5}ZrTi(PO₄)₃

Ca_{0.55}5Zr_{1.9}Al_{0.1}(PO₄)₃

Ca_{0.6}Zr_{1.8}Al_{0.2}(PO₄)₃

Ca_{0.75}Zr_{1.5}Al_{0.5}(PO₄)₃

Ca_{0.3}Zr_{1.4}Nb_{0.5}Al_{0.1}(PO₄)₃

Ca_{0.55}Zr_{1.4}Ti_{0.5}Al_{0.1}(PO₄)₃

Ca_{0.6}Zr_{1.6}Ti_{0.2}Al_{0.2}(PO₄)₃

Ca_{0.6}Zr_{1.3}Ti_{0.5}Al_{0.2}(PO₄)₃

The production method of the filler of the present invention is not particularly limited. However, it is preferred that the filler of the present invention is a hexagonal phosphate produced by the method for producing a hexagonal phosphate of the present invention.

A method for producing a hexagonal phosphate of the present invention is characterized by including the steps of mixing a tetravalent laminar metal phosphate, a compound of at least one divalent metal selected from the group consisting of alkaline earth metals, Zn, Cu, Ni and Mn and an m-valent metal compound to obtain a mixture, and calcinating the mixture to obtain the hexagonal phosphate represented by formula (1):

AₓB_{y}C_{z}(PO₄)₃.nH₂O (1)

In formula (1), A is at least one divalent metal selected from the group consisting of alkaline earth metals, Zn, Cu, Ni and Mn; B is at least one tetravalent metal selected from the group consisting of Zr, Ti, Hf, Ce and Sn; C is an m-valent metal; x, y and z are positive numbers satisfying 1.75<y+z<2.25 and 2x+4y+mz=9; n is 0 or a positive number of no more than 2; and m is an integer of 3 to 5.

According to the method for producing a hexagonal phosphate of the present invention, by selecting the particle diameter of the tetravalent laminar metal phosphate used as a starting material, the primary particle diameter of the obtained hexagonal phosphate can be controlled. In addition, by selecting the temperature condition during calcination, production of the hexagonal phosphate which exhibits low thermal expansion is sufficiently promoted while preventing sintering and thus the product obtained after calcination can be easily crushed to primary particles. Therefore the hexagonal phosphate particles can be provided that have excellent low thermal expansion and can provide preferable flowability and meet the requirements for providing fine shapes when the particles are used as a filler.

The main starting material that can be used for producing the hexagonal phosphate as the filler of the present invention is a tetravalent metal phosphate. The tetravalent laminar metal phosphate may be a hydrate salt. Known tetravalent metals in tetravalent laminar metal phosphates include Ti, Ge, Zr, Sn, Hf, Ce and the like, among which Ti, Zr, Sn and Hf are preferred and Ti, Zr and Hf are more preferred because of availability of starting materials and the low cost thereof. Two or more tetravalent laminar metal phosphates may be used in combination or double salts may be preferably used. Tetravalent metal phosphates are easily controlled for the particle diameter thereof by a wet method or a hydrothermal method and easily provide fine particles having particular particle diameters. Because a tetravalent metal phosphate can be synthesized in the form devoid of alkali metal, it is a suitable starting material of a hexagonal phosphate that does not contain an alkali metal.

A tetravalent laminar metal phosphate is a laminar crystal having two-dimensional laminar space. It has been known that tetravalent laminar metal phosphates are classified into, according to the phosphate group and water of crystallization included therein, α-crystals containing (HPO₄)₂.H₂O, β-crystals containing the anhydride thereof, (HPO₄)₂, γ-crystals represented by (H₂PO₄)(PO₄).2H₂O and the like. Tetravalent laminar metal phosphates have been known as ion exchangers. Regarding the difference in these crystal systems, it has been studied that, since the difference in the species of the tetravalent metal and in the crystalline system results in the difference in the interlayer distance, selectivity with regard to exchanged positive ions is provided. However, it was not known until now that using the tetravalent laminar metal phosphate particles as a starting material for production of hexagonal phosphate particles creates a product having characteristic low thermal expansion.

A tetravalent laminar metal phosphate preferably used as a starting material of hexagonal phosphate particles to be used as a filler is α-crystal or γ-crystal because it can easily provide fine particles by a wet method or a hydrothermal method, among which α-crystal is more preferred. Known examples of preferred tetravalent laminar metal phosphates include:
α-laminar zirconium phosphate: Zr(HPO₄)₂.H₂O
γ-laminar zirconium phosphate: Zr(H₂PO₄)(PO₄).2H₂O
α-laminar titanium phosphate: Ti(HPO₄)₂.H₂O
γ-laminar titanium phosphate: Ti(H₂PO₄)(PO₄).2H₂O
α-laminar germanium phosphate: Ge(HPO₄)₂.H₂O
α-laminar tin phosphate: Sn(HPO₄)₂.H₂O
α-laminar hafnium phosphate: Hf(HPO₄)₂.H₂O
γ-laminar hafnium phosphate: Hf(H₂PO₄)(PO₄).2H₂O
α-laminar lead phosphate: Pb(HPO₄)₂.H₂O
α-laminar cerium phosphate: Ce(HPO₄)₂.1.33H₂O
α-laminar cerium phosphate: Ce(HPO₄)₂.2H₂O.

The number of the molecules of water of crystallization may not be necessarily 1 or 2. Tetravalent metal phosphates having n water molecules of crystallization can be similarly used in the present invention (provided that 0≦n<6).

Among the specific examples of the tetravalent metal phosphates described above, a more preferred is one or more selected from the α-laminar zirconium phosphate, the γ-laminar zirconium phosphate, the α-laminar titanium phosphate, the γ-laminar titanium phosphate: Ti, the α-laminar hafnium phosphate and the γ-laminar hafnium phosphate and a particularly preferred is one or more selected from the α-laminar zirconium phosphate, the α-laminar titanium phosphate and the α-laminar hafnium phosphate. It is also preferable to use two or more tetravalent metal phosphates in combination, and it is particularly preferred to use the α-laminar zirconium phosphate and the α-laminar hafnium phosphate at a molar ratio of Hf/Zr of 3/7 to 0.1/9.9.

As the particle diameter of a tetravalent metal phosphate used as a starting material affects the particle diameter of the resulting hexagonal phosphate, it is preferable to choose the particle diameter of the tetravalent metal phosphate according to the desired resulting particle diameter. The particle diameter of a tetravalent metal phosphate used as a starting material can be determined, for example, on a laser diffraction particle size analyzer by subjecting the tetravalent metal phosphate dispersed in deionized water to the measurement and using the median diameter obtained by analysis based on the volume as a representing value of the particle diameter. It is preferable that a hexagonal phosphate obtained by the production method of the present invention has low median diameter when the hexagonal phosphate is used as a filler component of a composition of glass or a resin for filling fine gaps or moulding fine shapes. However, an extremely low median diameter may rather increase the specific surface area, resulting in reduction of flowability. Therefore, the filler preferably has a median diameter of 0.05 to 50 μm, more preferably 0.1 to 10 μm, and yet more preferably 0.5 to 5 μm. In order to obtain a hexagonal phosphate having such a particle diameter in the production method of the present invention, the tetravalent metal phosphate used as a starting material preferably has a median diameter of 0.05 to 50 μm, more preferably 0.1 to 10 μm, and yet more preferably 0.5 to 5 μm.

It is preferable that a hexagonal phosphate obtained by the production method of the present invention has low maximum particle diameter when the hexagonal phosphate is used as a filler component of a composition of glass or a resin for filling fine gaps or moulding fine shapes. A hexagonal phosphate used for a filler preferably has a maximum particle diameter of 20 μm or less, more preferable 15 μm or less, and yet more preferably 10 μm or less. The maximum particle diameter is also preferably 0.05 μm or more. In order to obtain the maximum particle diameter within the range, it is preferable that the tetravalent metal phosphate used as a starting material has a maximum particle diameter of 50 μm or less, more preferably 20 μm or less, and yet more preferably 10 μm or less. In order to prevent production of sintered particles having large particle diameter by sintering, it is effective to carry out calcination at 1,300° C. or lower and carry out a crushing step after the calcination. The tetravalent metal phosphate preferably has a maximum particle diameter of 0.05 μm or more. The maximum particle diameter, for example, can be determined on a laser diffraction particle size analyzer.

Examples of a compound of at least one divalent metal which can be used as a starting material for synthesis of a hexagonal phosphate and is selected from the group consisting of alkaline earth metal compounds, Zn, Cu, Ni and Mn include oxides, hydroxides, salts and the like. Among the compound of at least one metal selected from the group consisting of alkaline earth metal compounds, Zn, Cu, Ni and Mn, a compound of Mg, Ca, Ba and/or Zn is preferred, a compound of Mg, Ca and/or Zn is more preferred, and a compound of Ca and/or Mg is yet more preferred. Two or more of the foregoing may be used in combination. In terms of low cost and availability as well as absence of generation of corrosive gas during calcination, hydroxides and oxides are preferred. A hydroxide and an oxide may be used in combination; however a hydroxide is preferred due to high reactivity thereof. Specific examples of the compound include Ca(OH)₂, CaO, Mg(OH)₂, MgO, Zn(OH)₂, ZnO and the like among which one or more selected from Ca(OH)₂, Mg(OH)₂ and Zn(OH)₂ are more preferred.

Calcination after addition of only an alkaline earth metal to an α-laminar tetravalent metal phosphate in order to obtain a hexagonal phosphate tends to lead to a partial deposition of a pyrophosphate. In order to prevent the deposition, the third component, an m-valent metal compound is used. The m-valent metal compound is preferably at least one metal selected from elements such as Zr, Ti, Hf, Ce, Sn, V, Nb, Al, Ga, Sc, Y and La, or a salt thereof. More preferable examples thereof include oxides, hydroxides, sulphates, chlorides and the like of the foregoing elements, and yet more preferably hydroxides and oxides which do not generate corrosive gas during calcination. Specific examples thereof include Zr(OH)₂, ZrO₂, Ti(OH)₄, TiO₂ (amorphous, anatase, rutile), Al(OH)₃, Al₂O₃, Nb₂O₅.nH₂O and the like.

The method for producing a hexagonal phosphate of the present invention is characterized in that three components, that is, tetravalent metal phosphate particles, an alkaline earth metal compound and an m-valent metal compound are mixed and then calcinated. m is an integer of 3 to 5. The m-valent metal compound is preferably a compound of at least one metal selected from the group consisting of Zr, Ti, Hf, Ce, Sn, V, Nb, Al, Ga, Sc, Y and La, more preferably a compound of at least one metal selected from the group consisting of Zr, Ti, Hf, Nb, Al and Y, and yet more preferably a compound of at least one metal selected from the group consisting of Zr, Ti, Nb and Al. Examples of the compound include the compound other than phosphates such as oxides, oxyhydroxides, hydroxides and salts, among which hydroxides, oxyhydroxides and oxides which do not generate corrosive gas during calcination are preferred and hydroxides and oxyhydroxides which have high reactivity are more preferred. Specific examples of preferred m-valent metal compounds include zirconium hydroxide Zr(OH)₄, zirconium oxyhydroxide ZrO(OH)₂, titanium hydroxide Ti(OH)₄, titanium oxyhydroxide TiO(OH)₂, titanium oxide TiO₂ (amorphous, anatase, rutile), aluminium hydroxide Al(OH)₃, aluminium oxide Al₂O₃, niobium oxide Nb₂O₅ and the like, among which ZrO(OH)₂, TiO₂, Nb₂O₅ and Al(OH)₃ are more preferred. Compounds having the metal C with different valences of m may be used in combination and the m-valent metal compounds may be hydrate compounds containing H₂O.

The mixing ratio of starting materials when a hexagonal phosphate is synthesized according to the production method of the present invention is basically, but is not necessarily, in conformity with the theoretical composition (mixing ratio in conformity with the composition formula) of the hexagonal phosphate to be synthesized. For example, addition of the compound of at least one metal selected from the group consisting of alkaline earth metal compounds, Zn, Cu, Ni and Mn in an amount that slightly exceeds the formula weight of the hexagonal phosphate to be synthesized is preferable because it facilitates crystallization at low temperature during calcination. Further, adding the m-valent metal compound in an amount slightly exceeding the formula weight of the hexagonal phosphate to be synthesized is preferable because a pyrophosphate, which tends to be produced as a by-product, is not likely to deposit.

The amount of the compound of at least one divalent metal selected from the group consisting of alkaline earth metal compounds, Zn, Cu, Ni and Mn relative to 1 mole of the starting material, tetravalent metal phosphate, is preferably 1- to 2-fold in mole, more preferably 1- to 1.5-fold in mole, and yet more preferably 1.01- to 1.2-fold in mole of the theoretical amount calculated from the formula weight of the hexagonal phosphate to be synthesized.

Similarly, the amount of the m-valent metal compound relative to 1 mole of the starting material, tetravalent metal phosphate, is preferably 1- to 1.5-fold in mole, more preferably 1- to 1.2-fold in mole, and yet more preferably 1.01- to 1.1-fold in mole of the theoretical amount calculated from the formula weight of the hexagonal phosphate to be synthesized.

In the present invention, it is preferred that three components of starting materials of the hexagonal phosphate are homogeneously mixed and then calcinated. The method of mixing is not particularly limited as far as the components are homogeneously mixed and may be either of a dry method and a wet method. Although the method of mixing is not particularly limited, examples of the dry method include mixing in a Henschel mixer, a Loedige mixer, a V-blender, a W-blender or a ribbon mixer. Possible examples of wet mixing include kneading of the mixture with pure water in a kneader, mixing of slurry of the mixture with a larger amount of pure water in a bead mill, mixing in a cement mixer, kneading in a planetary mixer and kneading in a three roll mill when the amount of the mixture is small. When the components are mixed by wet mixing, the starting materials after mixing are preferably dried before calcination.

Because the starting materials are in the form of fine powder, the product of dry mixing is bulky and requires an extra space for calcination. The product of dry mixing also has low thermal conductivity, resulting in slow calcination reaction. Therefore, the mixed starting materials may be moulded on a press and the like into pellets.

The temperature of calcination of the starting material mixture in the present invention may depend on the composition of starting materials and is a temperature at or higher than the temperature at which a tetravalent laminar metal phosphate is converted to a hexagonal phosphate. In order to increase the crystallinity and obtain uniform composition, the temperature of calcination is preferably 650° C. or higher, more preferably 700° C. or higher, and yet more preferably 750° C. or higher. An extremely high temperature of calcination may produce large particles due to sintering and dissolution-reprecipitation of crystals, making control of the particle size difficult. Therefore, the temperature of calcination is preferably 1400° C. or lower, more preferably 1350° C. or lower, and yet more preferably 1300° C. or lower. A short calcination period may increase the production efficiency while a long calcination period tends to stabilize the product quality. Therefore the calcination period is preferably from 30 minutes to 24 hours. A calcination method is not particularly limited as far as it can heat the starting material mixture to a predetermined temperature and may be any of a method in which the starting material mixture is placed in a box with a lid and calcinated in an electric furnace or a gas furnace, a method in which the starting material mixture is heated in a rotary kiln and the like while being fluidized.

A grinding method of the calcinated product is preferably the one that allows grinding of the calcinated product into primary particles. Examples of the method include methods using a dry jet mill, a wet jet mill, a ball mill, a pin mill and the like.

The particle diameter of a hexagonal phosphate in the present invention can be defined on a laser diffraction particle size analyzer, for example, by subjecting the hexagonal phosphate dispersed in deionized water to the measurement and using the median diameter obtained by analysis based on the volume as a representing value of the particle diameter. When the hexagonal phosphate is used as a low thermal expansion filler, the hexagonal phosphate having an excessively low particle diameter may unnecessarily increase the viscosity of the composition, making handling of the composition difficult, and the hexagonal phosphate having an excessively high particle diameter is not suitable for filling fine gaps such as in semiconductor devices. Therefore, it is essential that the particle diameter is, in terms of the median diameter, 0.05 μm or more and 50 μm or less and the median diameter is preferably 0.1 μm or more and 10 μm or less, and more preferably 0.5 μm or more and 5 μm or less. Considering the processability for various products, not only the median diameter but also the maximum particle diameter is important. The filler preferably has a maximum particle diameter of 50 μm or less, more preferably 20 μm or less, and yet more preferably 10 μm or less. The maximum particle diameter is also preferably 0.05 μm or more.

A filler of the present invention is a hexagonal phosphate having high purity. The hexagonal phosphate has high chemical purity and high crystalline purity and is uniformly crystallized, and thus has less change in properties due to corrosion by glass upon melting thereof with glass and enables efficient control of thermal expansion. The crystalline purity of the hexagonal phosphate as a filler can be determined in powder X-ray diffraction by comparing intensities of main peaks with a standard X-ray diffraction pattern or by confirming the presence or absence of impurity peaks resulting from crystal components other than the hexagonal phosphate. The hexagonal phosphate can also be chemically analyzed for the composition thereof by nondestructive analysis such as X-ray fluorescence or by dissolving the crystal in an oxidant or a strong acid containing hydrofluoric acid and measuring the absolute value of the contents of metals and the P component by inductively coupled plasma (ICP) optical emission spectrometry. Water including water of crystallization and attached water can be measured by thermal analysis such as thermogravimetry-differential thermal analysis (Tg-DTA) and the like.

With regard to the preferred crystalline purity, it is preferable that the main peak of a desired hexagonal phosphate detected in X-ray diffraction has an intensity of 90% or more, and more preferably 95% or more of the corresponding peak of a standard substance (the peak intensity is proportional to % by weight). With regard to the chemical purity, it is similarly preferable that a desired hexagonal phosphate accounts for 90% by weight or more, and more preferably 95% by weight or more of the weight of the solid matters. As a purity of a hexagonal phosphate which is a combination of these measures, the hexagonal phosphate preferably has a product of the crystalline purity and the chemical purity of 90% by weight or more, and more preferably 95% by weight or more. The upper limit of the purity is obviously 100% by weight.

The filler of the present invention can be used in any form without limitation and can be appropriately mixed with other components or can be used to form a complex with other materials depending on the application. For example, the filler can be used in various forms such as powder, a dispersion containing powder, particles containing powder, a paint containing powder, a fibre containing powder, a plastic containing powder and a film containing powder, and can be appropriately used for a material that requires to have controlled thermal expansion. The filler of the present invention may further include other fillers, if necessary, in order to adjust the processability and thermal expansion. Specific examples of other fillers include such low thermal expansion fillers as cordierite, zirconium phosphotungstate, zirconium tungstate, β-spodumene, β-eucryptite, lead titanate, aluminium titanate, mullite, zircon, silica, celsian, willemite and alumina.

The filler of the present invention may be used for a sealing glass which is a sealing material for electronic components such as packages with high reliability including elements, e.g. cathode-ray tubes, plasma display panels, a vacuum fluorescent display, an organic EL, FEDs, semiconductor integrated circuits, crystal oscillators and SAW filters. It is desirable that a sealing glass for hermetically sealing electronic components such as cathode-ray tubes, plasma display panels and fluorescent display tubes can be used for sealing at a temperature as low as possible in order to avoid an adverse effect to the entity to be sealed. Due to this, sealing materials containing lead-containing low melting point glasses have been widely used so far. However, there is a need for development of a lead-free sealing material in recent years due to environmental consciousness.

Meanwhile a main component of a sealing glass, a low melting point glass, has higher thermal expansion than the entity to be sealed such as glass, and thus the thermal expansion of the low melting point glass is generally adjusted by adding a low thermal expansion filler. However, lead-free glasses such as lead-free phosphate glass and bismuth glass have further increased thermal expansion compared to conventional lead glasses, and thus addition of a conventional low thermal expansion filler thereto may not be able to adjust the coefficient of thermal expansion of the sealing material to a desired level or may impair the flowability.

The glass composition of the present invention includes the filler of the present invention, and preferably includes a mixture of glass, more preferably a low melting point glass which is a sealing glass, and the filler of the present invention. Powder of the low melting point glass may contain a well-known main component. Examples of the composition of the glass include the following, among which lead-free glass is preferred due to environmental consciousness:

Bi₂O₃ (50 to 85% by weight)-ZnO (10 to 25% by weight)-Al₂O₃ (0.1 to 5% by weight)-B₂O₃ (2 to 20% by weight)-MO (0.2 to 20% by weight, wherein M is an alkaline earth metal);

SnO (30 to 70% by weight)-ZnO (0 to 20% by weight)-Al₂O₃ (0 to 10% by weight)-B₂O₃ (0 to 30% by weight)-P₂O₅ (5 to 45% by weight);

PbO (70 to 85% by weight)-ZnO (7 to 12% by weight)-SiO₂ (0.5 to 3% by weight)-B₂O₃ (7 to 10% by weight)-BaO (0 to 3% by weight); and

V₂O₅ (28 to 56% by weight)-ZnO (0 to 40% by weight)-P₂O₅ (20 to 40% by weight)-BaO (7 to 42% by weight).

The amount of the filler added to the glass composition is preferably 5% by volume or more and more preferably 10% by volume or more because an increased amount of filler may easily provide the effect. On the other hand, a decreased amount of filler tends to provide preferable flowability of the composition or preferable adhesiveness upon sealing, and thus the amount of the filler is preferably 40% by volume or less and more preferably 35% by volume or less. A sealing glass is often mixed with a vehicle and used as a paste composition. The vehicle preferably includes a solute, 0.5 to 2% by weight of nitrocellulose, and a solvent, 98 to 99.5% by weight of isoamyl acetate or butyl acetate.

The filler of the present invention may be added to a sealing glass according to any publicly known method. Examples of the method include a method in which glass powder and a low thermal expansion filler are directly mixed in a mixer, a method in which a low thermal expansion filler is added upon pulverization of bulky glass in order to simultaneously pulverize and mix, a method in which glass powder and a low thermal expansion filler are separately added to a material of a paste such as a vehicle, and the like.

The filler of the present invention preferably has a coefficient of thermal expansion of 130×10⁻⁷ (/K) or less, more preferably 100×10⁻⁷ to 130×10⁻⁷ (/K), and yet more preferably 110×10⁻⁷ to 129×10⁻⁷ (/K), as measured by adding the filler to lead-free low melting point phosphate glass (SnO—P₂O₃—ZnO—Al₂O₃—B₂O₃) powder at 20% by volume of the total amount, moulding the mixture to obtain a cylindrical moulded article of 15 mm diameter and 5 mm height, placing the moulded article on a glass plate and maintaining them in an electric furnace at 500° C. for 10 minutes for calcination, making the surface of the calcinated moulded article smooth and measuring the coefficient of thermal expansion from 30° C. to 300° C. with a heating rate of 10° C./min on a thermomechanical analyzer TMA2940 produced by TA-Instruments.

When lead-free low melting point phosphate glass (K₂O—P₂O₃—Al₂O₃—Na₂O—CaO—F₂) powder is used instead of the lead-free low melting point phosphate glass (SnO—P₂O₃—ZnO—Al₂O₃—B₂O₃) powder in the above measurement, the filler preferably has a coefficient of thermal expansion of 128×10⁻⁷ (/K) or less, more preferably 100×10⁻⁷ to 128×10⁻⁷ (/K), and yet more preferably 110×10⁻⁷ to 126×10⁻⁷ (/K).

### Applications

The filler of the present invention can be effectively used for a sealing glass which is a sealing material for electronic components such as packages with high reliability including elements, e.g. cathode-ray tubes, plasma display panels, a vacuum fluorescent display, an organic EL, FEDs, semiconductor integrated circuits, crystal oscillators and SAW filters. The filler may be often mixed with a sealing glass and a vehicle and used as a paste composition.

The filler of the present invention is particularly superior in that compared to conventional hexagonal phosphates, it does not contain an alkali metal and is in the form of fine particles. The filler provides excellent processability and low thermal expansion when it is used for a glass composition.

The method for producing a hexagonal phosphate of the present invention is particularly superior in that, compared to conventional hexagonal phosphates, it can produce the hexagonal phosphate that does not contain an alkali metal. The method can provide a hexagonal phosphate which does not contain an alkali metal and has controlled particle diameter and purity in an inexpensive and simple manner.

### EXAMPLES

The present invention is hereinafter more specifically described by way of Examples, which do not limit the present invention. The composition formula was calculated by dissolving a synthesized hexagonal phosphate in hydrofluoric acid and nitric acid and measuring the contents of metals and the P component by ICP optical emission spectrometry. The composition formulae of other substances were also calculated in the same manner. The composition formula of a substance containing water of crystallization was calculated after measurement of water content by Tg-DTA analysis and the chemical purity in relation to the determined composition formula was calculated. Generation of hexagonal crystalline phase was confirmed by powder X-ray diffraction, the crystalline purity was determined based on a standard X-ray diffraction pattern and the purity was obtained as a product of the chemical purity and the crystalline purity. The median diameter and the maximum particle diameter were measured by a laser diffraction particle size analyzer and calculated based on the volume.

### Powder X-Ray Diffraction

The crystalline system of a hexagonal phosphate obtained by the production method of the present invention can be confirmed by powder X-ray diffraction analysis. Powder X-ray diffraction analysis may be carried out by following JIS K0131-1996, for example. Although the JIS standard does not define the applied voltage to an X-ray tube, X-ray diffraction was measured in the present Examples with CuKα radiation generated with an X-ray tube containing a Cu target with an applied voltage of 40 kv and a current value of 150 mA. If a sample contains a crystalline substance, the X-ray diffraction pattern contains an acute-angled diffraction peak. From the obtained powder X-ray diffraction pattern, the diffraction angle 2θ of the diffraction peak is then determined, the distance d between the planes in the crystal is calculated from the relation of λ=2d sin θ and thus the crystalline system can be identified. CuKα radiation has λ of 1.5418 angstroms.

### Example 1

### Synthesis of Hexagonal Phosphate A

An α-laminar zirconium phosphate (Zr(HPO₄)₂.H₂O) having a median diameter of 2 μm, NS-10TZ produced by Toagosei Co., Ltd. (904 g), 147 g of zirconium oxyhydroxide (ZrO(OH)₂.H₂O) and 90 g of a reagent grade of calcium hydroxide (Ca(OH)₂) were mixed in a 20 L Henschel mixer for 5 minutes. Water (2 L) was added to the mixture to obtain slurry which was placed in an enamel tray of 30 cm square by 10 cm deep and dried at 150° C. for 24 hours.

A bulky substance after drying was placed in a saggar made of alumina, heated to 1100° C. over 6 hours in an electric furnace and calcinated at 1100° C. for 6 hours. The bulky substance after calcination was ground in a ball mill, further crushed in a dry jet mill to primary particles to give hexagonal phosphate A.

The powder X-ray diffraction pattern of hexagonal phosphate A obtained with CuKα radiation is shown in FIG. 1. As the X-ray diffraction pattern of FIG. 1 was completely identical to the peaks (23.4, 31.2, 20.2, etc. as 2θ) of ASTM-pdf card No. 33-321 hexagonal CaZr₄(PO₄)₆, it was found that the hexagonal phosphate A did not contain crystalline impurities other than the hexagonal crystal. Namely, the crystalline purity was 100% by weight, and thus the composition formula was determined, the chemical purity was directly regarded as the purity of the hexagonal phosphate. The results of measurements of the median diameter, maximum particle diameter and the like are summarized in Table 1.

### Example 2

### Synthesis of Hexagonal Phosphate B

An α-laminar zirconium phosphate (Zr(HPO₄)₂.H₂O) having a median diameter of 2 μm, NS-10TZ produced by Toagosei Co., Ltd. (904 g), 147 g of zirconium oxyhydroxide (ZrO(OH)₂.H₂O) and 70 g of a reagent grade of magnesium hydroxide (Mg(OH)₂) were mixed in a 20 L Henschel mixer for 5 minutes. Water (2 L) was added to the mixture to obtain slurry which was placed in an enamel tray of 30 cm square by 10 cm deep and dried at 150° C. for 24 hours.

A bulky substance after drying was placed in a saggar made of alumina and calcinated in an electric furnace at 900° C. (heat-up time: 6 hours) for 6 hours. The bulky substance after calcination was ground in a ball mill, further crushed in a jet mill to primary particles to give hexagonal phosphate B. Powder X-ray diffraction was carried out in the same manner as Example 1 and it was confirmed that no crystalline impurities other than the hexagonal crystal was contained. The results of measurements of the composition formula, purity, median diameter and the like are summarized in Table 1.

### Example 3

### Synthesis of Hexagonal Phosphate C

An α-laminar zirconium phosphate (Zr(HPO₄)₂.H₂O) having a median diameter of 2 μm, NS-10TZ produced by Toagosei Co., Ltd. (904 g), 165 g of niobic acid (Nb₂O₅: containing H₂O, purity as Nb₂O₅: 80% by weight) and 90 g of a reagent grade of calcium hydroxide were mixed in a 20 L Henschel mixer for 5 minutes. Water (2 L) was added to the mixture to obtain slurry which was placed in an enamel tray of 30 cm square by 10 cm deep and dried at 150° C. for 24 hours.

A bulky substance after drying was placed in a saggar made of alumina and calcinated in an electric furnace at 1200° C. (heat-up time: 6 hours) for 6 hours. The bulky substance after calcination was ground in a ball mill, further crushed in a jet mill to primary particles to give hexagonal phosphate C. Powder X-ray diffraction was carried out in the same manner as Example 1 and it was confirmed that no crystalline impurities other than the hexagonal crystal was contained. The results of measurements of the composition formula, purity, median diameter and the like are summarized in Table 1.

### Example 4

### Synthesis of Hexagonal Phosphate D

An α-laminar zirconium phosphate (Zr(HPO₄)₂.H₂O) having a median diameter of 2 μm, NS-10TZ produced by Toagosei Co., Ltd. (904 g), 118 g of zirconium oxyhydroxide (ZrO(OH)₂.H₂O), 16 g of a reagent grade of aluminium hydroxide and 90 g of a reagent grade of calcium hydroxide were mixed in a 20 L Henschel mixer for 5 minutes. Water (2 L) was added to the mixture to obtain slurry which was placed in an enamel tray of 30 cm square by 10 cm deep and dried at 150° C. for 24 hours.

A bulky substance after drying was placed in a saggar made of alumina and calcinated in an electric furnace at 1200° C. (heat-up time: 6 hours) for 6 hours. The bulky substance after calcination was ground in a ball mill, further crushed in a jet mill to primary particles to give hexagonal phosphate D. Powder X-ray diffraction was carried out in the same manner as Example 1 and it was confirmed that no crystalline impurities other than the hexagonal crystal was contained. The results of measurements of the composition formula, purity, median diameter and the like are summarized in Table 1.

### Example 5

### Synthesis of Hexagonal Phosphate E

An α-laminar zirconium phosphate (Zr(HPO₄)₂.H₂O) having a median diameter of 2 μm, NS-10TZ produced by Toagosei Co., Ltd. (904 g), 80 g of a reagent grade of anatase-type titanium oxide and 90 g of a reagent grade of calcium hydroxide were mixed in a 20 L Henschel mixer for 5 minutes. While adding 2 L of water to the mixture, the mixture was transferred into an enamel tray of 30 cm square by 10 cm deep and dried at 150° C. for 24 hours.

A bulky substance after drying was placed in a saggar made of alumina and calcinated in an electric furnace at 1200° C. (heat-up time: 6 hours) for 6 hours. The bulky substance after calcination was ground in a ball mill, further crushed in a jet mill to primary particles to give hexagonal phosphate E. Powder X-ray diffraction was carried out in the same manner as Example 1 and it was confirmed that no crystalline impurities other than the hexagonal crystal was contained. The results of measurements of the composition formula, purity, median diameter and the like are summarized in Table 1.

### Example 6

### Synthesis of Hexagonal Phosphate F

An α-laminar titanium phosphate Ti(HPO₄)₂.H₂O having a median diameter of 1 μm (774 g), 80 g of a reagent grade of anatase-type titanium oxide and 90 g of a reagent grade of calcium hydroxide were mixed in a 20 L Henschel mixer for 5 minutes. While adding 2 L of water to the mixture, the mixture was transferred into an enamel tray of 30 cm square by 10 cm deep and dried at 150° C. for 24 hours.

A bulky substance after drying was placed in a saggar made of alumina and calcinated in an electric furnace at 1150° C. (heat-up time: 6 hours) for 6 hours. The bulky substance after calcination was ground in a ball mill, further crushed in a jet mill to primary particles to give hexagonal phosphate F. Powder X-ray diffraction was carried out in the same manner as Example 1 and it was confirmed that no crystalline impurities other than the hexagonal crystal was contained. The results of measurements of the composition formula, purity, median diameter and the like are summarized in Table 1.

### Comparative Example 1

After mixing 3.7 g of calcium hydroxide, 24.6 g of zirconia and 34.5 g of diammonium hydrogen phosphate, the mixture was calcinated at 1100° C. for 10 hours. The obtained bulky hexagonal phosphate was ground in a ball mill and screened through a 325-mesh sieve. The results of measurements of the composition formula, purity, median diameter and the like of the obtained hexagonal phosphate g are summarized in Table 1. The powder X-ray diffraction pattern of hexagonal phosphate g obtained with CuKα radiation is shown in FIG. 2. By comparing the X-ray diffraction pattern in FIG. 2 with that of hexagonal phosphate A of Example 1 determined under the same conditions, it was found that the intensities of the diffraction peaks derived from hexagonal Ca_{0.5}Zr₂(PO₄)₃ indicated in ASTM-pdf card No. 33-321 were less than a half of the intensities of A and diffraction peaks other than those of hexagonal Ca_{0.5}Zr₂(PO₄)₃ appeared, and thus the amount of the hexagonal phosphate produced was not sufficient.

As described above, substances having different crystalline systems showed the same chemical composition Ca_{0.5}Zr₂(PO₄)₃. Therefore, it was configured to reflect the content of the hexagonal system (crystalline purity) in the chemical purity based on ICP analysis to provide the purity of the obtained hexagonal phosphate. Namely, the intensity of a peak in the X-ray diffraction pattern of hexagonal phosphate g, that corresponded to the maximum peak in the X-ray diffraction pattern of the hexagonal phosphate of Example 1 which had the same composition formula and was assumed to be without crystalline impurities other than the hexagonal crystal was regarded as the proportion of the hexagonal phosphate, and the proportion was multiplied by the chemical purity. In Comparative Example 1, the chemical purity was 99.1% by weight and the height of the X-ray diffraction peak at 2θ=20.2 of Comparative Example 1 relative to the height of the X-ray diffraction peak at 2θ=20.2 of Example 1 was 28.5%. Therefore, by multiplying 99.1% by weight by 28.5%, the purity of hexagonal Ca_{0.5}Zr₂(PO₄)₃ of Comparative Example 1 was determined to be 28.2% by weight.

### Comparative Example 2

After mixing 3.7 g of calcium hydroxide, 24.6 g of zirconia and 34.5 g of diammonium hydrogen phosphate, the mixture was calcinated at 1400° C. for 10 hours. The obtained bulky hexagonal phosphate was ground in a ball mill and screened through a 325-mesh sieve. The results of measurements of the composition formula, purity, median diameter and the like of the obtained hexagonal phosphate h are summarized in Table 1. Powder X-ray diffraction was carried out in the same manner as Comparative Example 1, the result was compared with the X-ray diffraction pattern of Example 1 and the purity was determined to be 94.6% by weight after multiplying by the chemical purity.

### Comparative Example 3

After mixing 2.9 g of magnesium hydroxide, 24.6 g of zirconia and 34.5 g of diammonium hydrogen phosphate, the mixture was calcinated at 900° C. for 10 hours. The obtained bulky hexagonal phosphate was ground in a ball mill and screened through a 325-mesh sieve. The results of measurements of the composition formula, purity, median diameter and the like of the obtained hexagonal phosphate i are summarized in Table 1. It was found by XRD analysis that the desired crystalline phase accounted for less than a half, and the result was then compared with the X-ray diffraction pattern of Example 2 in the same manner as Comparative Example 1, and the purity was determined to be 26.0% by weight after multiplying by the chemical purity.

### Comparative Example 4

After mixing 2.9 g of magnesium hydroxide, 24.6 g of zirconia and 34.5 g of diammonium hydrogen phosphate, the mixture was calcinated at 1400° C. for 10 hours. The obtained bulky hexagonal phosphate was ground in a ball mill and screened through a 325-mesh sieve. The results of measurements of the composition formula, purity, median diameter and the like of the obtained hexagonal phosphate j are summarized in Table 1. Powder X-ray diffraction was carried out in the same manner as Example 2, the result was compared with the X-ray diffraction pattern of Example 1 and the purity was determined to be 94.8% by weight after multiplying by the chemical purity.

### Comparative Example 5

After mixing 13.8 g of potassium carbonate, 24.6 g of zirconia and 34.5 g of diammonium hydrogen phosphate, 1.5 g of a sintering auxiliary agent, magnesium oxide, was further added. The mixture was calcinated at 1450° C. for 15 hours. The obtained bulky hexagonal zirconium phosphate was ground in a ball mill and screened through a 325-mesh sieve. The results of measurements of the composition formula, median diameter and the like of the obtained hexagonal zirconium phosphate k are summarized in Table 1. In Comparative Example 5, the crystalline purity was determined based on the standard X-ray diffraction pattern form according to the ASTM-pdf card and the purity was determined by multiplying by the chemical purity.

### Comparative Example 6

After mixing 12.7 g of sodium carbonate, 24.6 g of zirconia containing hafnium at 1.9% by weight and 34.5 g of diammonium hydrogen phosphate, the mixture was calcinated at 1450° C. for 12 hours. The obtained bulky hexagonal zirconium phosphate was ground in a ball mill and screened through a 325-mesh sieve. The results of measurements of the composition formula, median diameter and the like of the obtained hexagonal zirconium phosphate p are summarized in Table 1. In Comparative Example 6, the crystalline purity was determined based on the standard X-ray diffraction pattern form according to the ASTM-pdf card and the purity was determined by multiplying by the chemical purity.

### Comparative Example 7

Commercially available zirconium phosphotungstate powder which was used as a low thermal expansion filler was designated as q and measured for the median diameter and the like. The results are shown in Table 1. In Comparative Example 7, the crystalline purity was determined based on the standard X-ray diffraction pattern form according to the ASTM-pdf card and the purity was determined by multiplying by the chemical purity.

### Comparative Example 8

Commercially available cordierite (2MgO.2Al₂O₃.5SiO₂) powder which was used as a low thermal expansion filler was designated as r and measured for the median diameter and the like. The results are shown in Table 1. In Comparative Example 8, the purity was not calculated because the X-ray diffraction pattern for intensity comparison was not available.

TABLE 1

| | Calcination | | | Median | Maximum |
|---|---|---|---|---|---|
| | temperature | | Purity | diameter | diameter |
| | (° C.) | Composition formula | (wt %) | (μm) | (μm) |
| Example 1 | 1100 | Ca_{0.5}Zr₂(PO₄)₃ | 99.1 | 1.2 | 3.8 |
| Example 2 | 900 | Mg_{0.5}Zr₂(PO₄)₃ | 98.9 | 1.3 | 6.7 |
| Example 3 | 1200 | Ca_{0.5}Zr_{1.5}Nb_{0.5}(PO₄)₃ | 98.8 | 2.4 | 7.6 |
| Example 4 | 1200 | Ca_{0.55}Zr_{1.9}Al_{0.1}(PO₄)₃ | 99.3 | 1.0 | 3.3 |
| Example 5 | 1200 | Ca_{0.5}Zr_{1.5}Ti_{0.5}(PO₄)₃ | 98.7 | 1.7 | 8.8 |
| Example 6 | 1150 | Ca_{0.5}Ti₂(PO₄)₃ | 99.1 | 2.1 | 8.8 |
| Comparative | 1100 | Ca_{0.5}Zr₂(PO₄)₃ | 28.2 | 13.3 | 79.4 |
| Example 1 | | | | | |
| Comparative | 1400 | Ca_{0.5}Zr₂(PO₄)₃ | 94.6 | 21.6 | 60.3 |
| Example 2 | | | | | |
| Comparative | 900 | Mg_{0.5}Zr₂(PO₄)₃ | 26.0 | 12.8 | 60.3 |
| Example 3 | | | | | |
| Comparative | 1400 | Mg_{0.5}Zr₂(PO₄)₃ | 94.8 | 18.3 | 69.2 |
| Example 4 | | | | | |
| Comparative | 1450 | KZr₂(PO₄)₃ | 96.4 | 13.3 | 39.2 |
| Example 5 | | | | | |
| Comparative | 1450 | Na_{1.2}Zr_{1.9}Hf_{0.05}(PO₄)₃ | 95.8 | 2.4 | 17.4 |
| Example 6 | | | | | |
| Comparative | — | Zr₂(WO₄)(PO₄)₂ | 97.2 | 15.0 | 60.3 |
| Example 7 | | | | | |
| Comparative | — | Cordierite | — | 10.4 | 34.3 |
| Example 8 | | | | | |

By comparing Example 1 with Comparative Examples 1 and 2, it is found that the filler of the present invention has higher purity, lower median diameter and lower maximum particle diameter than those of Comparative Examples obtained by the conventionally known production method, and thus is excellent for semiconductor applications. The same findings can be reached by comparing Example 2 with Comparative Examples 3 and 4. Comparative Example 6 containing an alkali metal gave the substance having a low median diameter, as has been known in the art. However, the fillers of the present invention and the fillers obtained by the method for producing a hexagonal phosphate of the present invention had lower maximum particle diameters and thus were superior.

### Example 7

Evaluation of Glass Composition with Lead-Free Low Melting Point Phosphate Glass 1

Filler A obtained in Example 1 was mixed with lead-free low melting point phosphate glass (SnO—P₂O₃—ZnO—Al₂O₃—B₂O₃: referred to as lead-free glass 1) powder so that the filler accounts for 20% by volume of the total amount and the mixture was moulded into a cylindrical moulded article of 15 mm diameter and 5 mm height to prepare moulded article A1. Moulded article A1 was placed on a glass plate and maintained in an electric furnace at 500° C. for 10 minutes for calcination. The surface of the calcinated moulded article A1 was made smooth and the coefficient of thermal expansion from 30° C. to 300° C. with a heating rate of 10° C./min was measured by a thermomechanical analyzer TMA2940 produced by TA-Instruments. The result is shown in Table 2.

Similarly, glass moulded articles B1 to F1 and h1 to r1 were respectively prepared with low thermal expansion fillers B to F prepared in Examples 2 to 6 and fillers h and j to r of Comparative Examples 2 and 4 to 8. Moulded article s1 was prepared without using a filler. The coefficient of thermal expansion of each moulded article prepared is shown in Table 2.

Evaluation of Glass Composition with Lead-Free Low Melting Point Phosphate Glass 2

Filler A obtained in Example 1 was mixed with lead-free low melting point phosphate glass (K₂O—P₂O₃—Al₂O₃—Na₂O—CaO—F₂: referred to as lead-free glass 2) powder so that the filler accounts for 20% by volume and the mixture was moulded into a cylindrical moulded article of 15 mm diameter and 5 mm height to prepare moulded article A2. Moulded article A2 was placed on a glass plate and maintained in an electric furnace at 600° C. (heat-up time: 2.5 hours) for 20 minutes for calcination. The surface of the calcinated moulded article A2 was made smooth and the coefficient of thermal expansion from 30° C. to 300° C. with a heating rate of 10° C./min was measured by a thermomechanical analyzer TMA2940 produced by TA-Instruments. The result is shown in Table 2.

Similarly, glass moulded articles B2 to F2 and h2 to r2 were respectively prepared with low thermal expansion fillers B to F prepared in Examples 2 to 6 and low thermal expansion fillers h and j to r prepared in Comparative Examples 2 and 4 to 8. Moulded article s2 was prepared without using a filler. The coefficient of thermal expansion of each moulded article prepared is shown in Table 2.

TABLE 2

| | Lead-free glass 1 | | Lead-free gass 2 | |
|---|---|---|---|---|
| | | Coefficient | | Coefficient |
| | | of thermal | | of thermal |
| | Moulded | expansion | Moulded | expansion |
| Filler | article | (/K) | article | (/K) |
| A (Example 7) | A1 | 129 × 10⁻⁷ | A2 | 126 × 10⁻⁷ |
| B (Example 8) | B1 | 120 × 10⁻⁷ | B2 | 115 × 10⁻⁷ |
| C (Example 9) | C1 | 130 × 10⁻⁷ | C2 | 128 × 10⁻⁷ |
| D (Example 10) | D1 | 120 × 10⁻⁷ | D2 | 116 × 10⁻⁷ |
| E (Example 11) | E1 | 125 × 10⁻⁷ | E2 | 121 × 10⁻⁷ |
| F (Example 12) | F1 | 123 × 10⁻⁷ | F2 | 117 × 10⁻⁷ |
| h (Comparative | h1 | 159 × 10⁻⁷ | h2 | 143 × 10⁻⁷ |
| Example 2) | | | | |
| j (Comparative | j1 | 145 × 10⁻⁷ | j2 | 140 × 10⁻⁷ |
| Example 4) | | | | |
| k (Comparative | k1 | 138 × 10⁻⁷ | k2 | 130 × 10⁻⁷ |
| Example 5) | | | | |
| p (Comparative | p1 | 151 × 10⁻⁷ | p2 | 140 × 10⁻⁷ |
| Example 6) | | | | |
| q (Comparative | q1 | 144 × 10⁻⁷ | q2 | 135 × 10⁻⁷ |
| Example 7) | | | | |
| r (Comparative | r1 | 137 × 10⁻⁷ | r2 | 134 × 10⁻⁷ |
| Example 8) | | | | |
| s (no addition) | s1 | 170 × 10⁻⁷ | s2 | 157 × 10⁻⁷ |

As apparent from Table 2, the glass moulded articles containing the filler of the present invention have a low coefficient of thermal expansion and have preferable and excellent low thermal expansion.

### INDUSTRIAL APPLICABILITY

The novel filler of the present invention has excellent productivity and processability as well as having excellent ability for controlling the thermal expansion when it is used for low melting point glass and the like. Therefore the filler can be used for a sealing glass for electronic components typically including cathode-ray tubes, PDPs, a vacuum fluorescent display, an organic EL and the like.

The method for producing a hexagonal phosphate of the present invention can provide a hexagonal phosphate having excellent productivity and processability and having controlled particle diameter. Therefore the hexagonal phosphate obtained by the production method of the present invention can be used as a filler for a sealing glass for electronic components such as cathode-ray tubes, PDPs, a vacuum fluorescent display and an organic EL.

1. A filler comprising hexagonal phosphate particles represented by the following formula (1) and having a median diameter of 0.05 μm or more and 10 μm or less based on the volume as measured by a laser diffraction particle size analyzer:
AₓB_{y}C_{z}(PO₄)₃.nH₂O (1)
wherein in formula (1), A is at least one divalent metal selected from the group consisting of alkaline earth metals, Zn, Cu, Ni and Mn; B is at least one tetravalent metal selected from the group consisting of Zr, Ti, Hf, Ce and Sn; C is at least one m-valent metal selected from the group consisting of Zr, Ti, Hf, Ce, Sn, V, Nb, Al, Ga, Sc, Y and La; x, y and z are positive numbers satisfying 1.75<y+z<2.25 and 2x+4y+mz=9; n is 0 or a positive number of no more than 2; and m is an integer of 3 to 5.

2. The filler according to claim 1, having a maximum particle diameter of 0.05 μm or more and 50 μm or less as measured by the laser diffraction particle size analyzer.

3. The filler according to claim 1, wherein in formula (1), A is at least one divalent metal selected from the group consisting of Mg, Ca, Ba and Zn; B is at least one tetravalent metal selected from the group consisting of Ti, Zr, Sn and Hf; and C is at least one m-valent metal selected from the group consisting of Zr, Ti, Hf, Nb, Al and Y.

4. The filler according to claim 1, wherein the hexagonal phosphate has a purity of 95% by weight or more and 100% by weight or less.

5. A glass composition comprising the filler according to claim 1.

6. The glass composition according to claim 5, wherein a glass of the glass composition is a lead-free glass.

7. A method for producing a hexagonal phosphate represented by formula (1), comprising the steps of:
mixing a tetravalent laminar metal phosphate, a compound of at least one divalent metal selected from the group consisting of alkaline earth metals, Zn, Cu, Ni and Mn and an m-valent metal compound to obtain a mixture; and
calcinating the mixture,
AₓB_{y}C_{z}(PO₄)₃.nH₂O (1)
wherein in formula (1), A is at least one divalent metal selected from the group consisting of alkaline earth metals, Zn, Cu, Ni and Mn; B is at least one tetravalent metal selected from the group consisting of Zr, Ti, Hf, Ce and Sn; C is an m-valent metal; x, y and z are positive numbers satisfying 1.75<y+z<2.25 and 2x+4y+mz=9; n is 0 or a positive number of no more than 2; and m is an integer of 3 to 5.

8. The method for producing a hexagonal phosphate according to claim 7, wherein the tetravalent metal is at least one selected from the group consisting of Zr, Ti, Hf, Ce and Sn; the divalent metal is at least one selected from the group consisting of Mg, Ca, Ba and Zn; and the m-valent metal is at least one selected from the group consisting of Zr, Ti, Hf, Ce, Sn, V, Nb, Al, Ga, Sc, Y and La.

9. The method for producing a hexagonal phosphate according to claim 7, wherein the tetravalent laminar metal phosphate is an α-crystal.

10. The method for producing a hexagonal phosphate according to claim 7, wherein the tetravalent laminar metal phosphate is particles having a median diameter of 0.05 μm or more and 10 μm or less based on the volume as measured by a laser diffraction particle size analyzer.

11. The method for producing a hexagonal phosphate according to claim 7, wherein a temperature of calcination is 650° C. or higher and 1400° C. or lower.

12. The method for producing a hexagonal phosphate according to claim 7, wherein the method further comprises the step of crushing the obtained phosphate to primary particles after the step of calcinating.
